(19) United States
(12) Patent Application Publication
(10) Pub. No.: US 2025/0314276 A1
(43) Pub. Date: Oct. 9, 2025

(54) SHOCK ABSORBING STOP AND LOCK

(71) Applicant: Robert C. Adams, Jr., Armada, MI (US)

(72) Inventor: Robert C. Adams, Jr., Armada, MI (US)

(21) Appl. No.: 19/087,082

(22) Filed: Mar. 21, 2025

Related U.S. Application Data
(60) Provisional application No. 63/575,974, filed on Apr. 8, 2024.

(51) Int. Cl. F16D 63/00; F16D 65/16; F16D 121/06; F16D 121/22; F16F 9/14

(52) U.S. Cl. CPC F16D 63/006; F16F 9/145; F16D 65/16; F16D 2121/06; F16D 2121/22; F16F 2222/12; F16F 2230/30; F16F 2232/02

(57) ABSTRACT

A rotary shock absorber and stop apparatus includes a stator assembly for a rotor. The stator assembly includes an inner plate, an outer plate, and a stator plate assembled together to define a plurality of cavities. The stator assembly includes first lobes that extend radially inwardly from concave surfaces disposed between each of the first lobes. The rotor includes second lobes that have a second convex surface on a radially outer periphery that is offset relative to the first concave surface. Spaces are defined between the second convex surfaces and the first concave surfaces through which fluid flows between high-pressure chambers and low-pressure chambers.

### REFERENCE TO RELATED APPLICATIONS

This application claims the benefit of U.S. provisional application Ser. No. 63/575,974 filed Apr. 8, 2024, the disclosure of which is hereby incorporated in its entirety by reference herein.

### TECHNICAL FIELD

This disclosure relates to emergency stop safety mechanism for a machine having a rotary shaft that gradually decelerates the rotary shaft in the event of a predetermined event until the shaft stops rotating thereby locking the shaft.

### BACKGROUND

Many markets and industries require a rotary shock absorbing stop. Machines for lifting loads and transferring loads employ rotary shafts that may include emergency stops in the event of a malfunction. Machines including emergency stops include, for example and not limited to, over-center tip devices, motion lock-out devices, people moving lifts, general purpose lifts, cranes, forklifts, self-dumping hoppers, vertical reciprocating conveyors, and the like.

Emergency stops available in the prior art include redundant drive trains, self-binding multiple lift systems, external brakes, and external locks. Such devices are costly, bulky, complex, and may be of only limited applicability. Emergency safety mechanisms are particularly important for lifts used to lift people.

This disclosure is directed to solving the above problems and other problems as summarized below.

### SUMMARY

The combination rotary shock absorbing stop and lock disclosed herein features a small footprint, high torque capacity, decelerates a falling or over-running load in a predetermined distance, does not wear out, is relatively lower in cost than brakes or redundant drives, and is fail-safe. The rotary shock absorbing stop functions to decelerate a load and then stops and holds the load.

The shock absorbing function is provided in the form of a squeeze film bearing that has a converging escape path for hydraulic oil, or the like. The rotary shock stop is easily resettable by rotating the shaft in the opposite rotary direction from the direction the shaft rotates when the load is falling.

According to one aspect of this disclosure, a rotary shock absorber and stop apparatus is disclosed that includes a stator assembly and a rotor. The stator assembly includes an inner plate, an outer plate, and stator plate assembled together to define a plurality of cavities. The stator plate includes a first plurality of lobes that extend radially inwardly from a first plurality of concave surfaces. The first plurality of concave surfaces are disposed between a pair of the first plurality of lobes. The rotor is received in the cavities and includes a second plurality of lobes that extend radially outwardly from a first plurality of convex surfaces disposed between two of the second plurality of lobes. The second plurality of lobes each have a second convex surface disposed on a radially outer periphery of the lobes. The second convex surfaces are offset relative to the first plurality of concave surfaces and defines a space therebetween. The space between the second plurality of convex surfaces and the first plurality of concave surfaces diverge from an inlet side through which a fluid is received in the space to an outlet side through which the fluid flows into an adjacent one of the plurality of cavities. At the outlet side the fluid is squeezed to a squeeze film thickness as the second plurality of lobes move in a first rotary direction. Rotation of the second plurality of lobes in the first rotary direction is stopped by contacting a circumferentially adjacent one of the first plurality of lobes.

Other alternative and optional aspects of this disclosure as it relates to the one aspect are described below.

The rotary shock absorber and stop apparatus further comprise a plurality of check valves disposed in a plurality of reset channels defined in either of the first plurality of lobes or each of the second plurality of lobes. Each of the reset channels are in fluid communication between two of the plurality of cavities to prevent the fluid from flowing when the lobes are moved in the first rotary direction. Each check valve allows the fluid to flow when the second plurality of lobes is moved in a second rotary direction when the rotary shock absorber and stop apparatus is reset.

Each of the second plurality of lobes is movably disposed in one of the plurality of cavities. The plurality of cavities define a low-pressure chamber between a first side of the first plurality of lobes and a first side of the second plurality of lobes. A high-pressure chamber is defined between a second side of the first plurality of lobes and a second side of the second plurality of lobes. The fluid flows from the high-pressure chamber of the plurality of cavities to the low-pressure chamber of the plurality of cavities when the first plurality of lobes the second plurality of lobes move relative to each other when a predetermined event occurs.

The rotary shock absorber and stop apparatus further comprises a plurality of check valves disposed in a plurality of reset channels defined in each of the first plurality of lobes or the second plurality of lobes. Each of the plurality of channels are in fluid communication between two of the plurality of cavities to prevent the fluid from flowing through the plurality of reset channels when the second plurality of lobes are moved in the first rotary direction. Each check valve allows the fluid to flow from the low-pressure chamber defined by the cavities when the second plurality of lobes moves in a second rotary direction. The rotary shock absorber and stop apparatus is reset by directing the fluid to flow through the plurality of reset channels from the low-pressure chamber of the plurality of cavities to the high-pressure chamber of the plurality of cavities when the second plurality of lobes moves in the second rotary direction.

The second plurality of lobes and the first plurality of lobes contact each other in a ready position in which pressure applied to the fluid in the cavities is the same throughout the cavities. When a predetermined event occurs such as when a load drops that is supported by a rotary shaft, the rotor rotates in a first rotary direction and creates a high-pressure chamber in the cavities at a leading surface of the second plurality of lobes and defines a low-pressure chamber of the cavities created at a trailing surface of the second plurality of lobes. The second plurality of lobes move in the first rotary direction until the second plurality of lobes contact a next adjacent one of first plurality of lobes thereby stopping rotation in the first rotary direction.

The first plurality of concave surfaces of the stator assembly are circular arcs. The first plurality of concave surfaces are offset relative to the second convex surfaces of the rotor to form the space that diverges from an inlet side to an outlet side of the space, wherein the outlet side is wider than the inlet side.

The rotary shock absorber and stop apparatus further comprise a ring adapted to be attached to a rotary shaft, wherein the ring has external splines that selectively engage and disengage a splined opening defined by the rotor that has internal splines. The ring shifts in an axial direction relative to the rotor to engage the internal splines of the rotor with the external splines of the ring when the rotor rotates in the first rotary direction. The ring is disconnected from the internal splines of the rotor in the ready position.

The internal splines and the external splines are tapered at a complementary angle to each other. The external splines are axially moved to engage the internal splines when the rotor rotates in the first direction caused by the falling load. The external splines disengage the internal splines to reset the rotary shock absorber and stop apparatus in a ready position.

The internal splines have a first plurality of spline teeth, and the external splines have a second plurality of spline teeth, wherein the internal splines and the external splines are twisted and extend in an axial direction and a circumferential direction.

The outer plate covers a first side of the stator plate and a first side of the rotor, the inner plate covers a second side of the stator plate and a second side of the rotor. A first inner seal is disposed between the outer plate and the first side of the rotor radially inboard from the plurality of cavities. A second inner seal is disposed between the inner plate and the second side of the rotor radially inboard from the plurality of cavities. A first outer seal is disposed between the outer plate and the first side of the stator plate radially outboard from the plurality of cavities. A second outer seal is disposed between the inner plate and the second side of the stator plate radially outboard from the plurality of cavities.

The outer plate covers a first side of the stator plate and a first side of the rotor, and the inner plate covers a second side of the stator plate and a second side of the rotor. A first inner pressure equalization groove is disposed between the outer plate and the first side of the rotor radially inboard from the plurality of cavities and outboard of the first inner seal. A second inner pressure equalization groove is disposed between the inner plate and the second side of the rotor radially inboard from the plurality of cavities and radially outboard of the second inner seal. A first outer pressure equalization groove is disposed between the outer plate and the first side of the stator plate radially outboard from the plurality of cavities and inboard of the first outer seal. A second outer pressure equalization groove is disposed between the inner plate and the second side of the stator plate radially outboard from the plurality of cavities and inboard of the second outer seal.

According to a second aspect of this disclosure, a rotary shock absorber and stop apparatus is disclosed that includes a stator assembly and a rotor. The stator assembly defines a plurality of cavities that are filled with a fluid. The stator assembly includes a first plurality of lobes. The stator assembly includes a first plurality of concave arcuate surfaces between each of the first plurality of lobes. The rotor is received in the plurality of cavities and includes a second plurality of lobes that each have a second plurality of convex arcuate surfaces on a radially outer periphery of the second plurality of lobes. The rotary shock absorber and stop apparatus is actuated when a load supported by the shaft falls causing the rotor to rotate in a first rotary direction relative to the stator assembly. The fluid flows from a high-pressure chamber to a low-pressure chamber through spaces defined by the first convex arcuate surfaces and the first concave surfaces. The fluid in the low-pressure chamber is subjected to lower pressure than is applied to the fluid in the high-pressure chamber as a result of the rotor rotating relative to the stator assembly. The fluid is squeezed between the first plurality of concave arcuate surfaces and the first plurality of convex arcuate surfaces. The first plurality of convex arcuate surfaces are offset relative to the second plurality of concave arcuate surfaces and define spaces therebetween that are convergent. When the rotor rotates in the first rotary direction the second plurality of lobes are driven into contact with the first plurality of lobes to stop rotation of the rotor.

Other alternative and optional aspects of this disclosure as it relates to the second aspect are described below.

A check valve may be disposed in either of the first plurality of lobes or second plurality of lobes. The check valve is in fluid communication with one of the low-pressure chambers and one of the high-pressure chambers to prevent the fluid from flowing from the high-pressure chamber to the low-pressure chamber when the rotary shock absorber and stop apparatus is actuated by the falling load supported by the shaft. The check valves allow the fluid to flow from the low-pressure chamber to the high-pressure chamber when the rotary shock absorber and stop apparatus is reset by rotating the rotor relative to the stator assembly in a second rotary direction, opposite the first rotary direction.

The second plurality of lobes and the first plurality of lobes contact each other in a ready position wherein pressure applied to the fluid in the cavities is the same throughout the cavities. The rotary shock absorber and stop apparatus is actuated by the falling load supported by the shaft. The rotor rotates in the first rotary direction with the high-pressure chamber of the cavities being created at a leading surface of the lobes and a low-pressure chamber of the cavities being created at a trailing surface of the lobes. The second plurality of lobes move in the first direction until the second plurality of lobes contact a next adjacent one of the first plurality of lobes thereby stopping rotation in the first direction.

The first plurality of concave arcuate surfaces are circular arcs and the second plurality of convex arcuate surfaces are circular arcs and are eccentric relative to the first plurality of concave arcuate surfaces to form spaces therebetween that are convergent.

The rotary shock absorber and stop apparatus further comprises a tapered spline ring including tapered external splines, wherein the rotor defines an opening including internal splines that are adapted to receive the external splines when the falling load supported by the shaft is sensed.

The internal splines and the external splines are tapered at a complementary angle. The external splines are axially moved in a first direction to engage the internal splines when actuated by the falling load supported by the shaft, wherein the external splines are moved in a second axial direction to disengage the internal splines to reset the rotary shock absorber and stop apparatus in a ready position.

The stator assembly further comprises a stator plate including the first plurality of lobes, an outer plate covering a first side of the stator plate and a first side of the rotor, and an inner plate covering a second side of the stator plate and a second side of the rotor.

The rotary shock absorber and stop apparatus further comprises a first inner seal disposed between the outer plate and the first side of the rotor assembly. The first inner seal is disposed radially inboard from the plurality of cavities. A second inner seal is disposed between the inner plate and the second side of the rotor assembly. The second inner seal is disposed radially inboard from the plurality of cavities. A first outer seal is disposed between the inner plate and the second side of the stator assembly. The first outer seal is disposed radially outboard from the plurality of cavities. A second outer seal is disposed between the outer plate and the second side of the stator assembly. The second outer seal is disposed radially outboard from the plurality of cavities.

The outer plate covers a first side of the stator plate and a first side of the rotor while the inner plate covers a second side of the stator plate and a second side of the rotor. A first inner pressure equalization groove is disposed between the outer plate and the first side of the rotor radially inboard from the cavities and outboard of the first inner seal. A second inner pressure equalization is disposed between the inner plate and the second side of the rotor radially inboard from the plurality of cavities and radially outboard of the second inner seal. A first outer pressure equalization groove is disposed between the outer plate and the second side of the stator plate radially outboard from the cavities and outboard of the first outer seal. A second outer seal pressure equalization groove is disposed between the inner plate and the second side of the stator plate radially outboard from the cavities and outboard of the first outer seal.

The above aspects of this disclosure and other aspects will be described below with reference to the attached drawings.

### BRIEF DESCRIPTION OF THE DRAWINGS

FIG. 1 is a perspective view of a rotary shock absorber and stop assembly.

FIG. 2 is an exploded perspective view of the rotary shock absorber and stop assembly of FIG. 1 showing the outer side thereof.

FIG. 3 is an exploded perspective view of the rotary shock absorber and stop assembly of FIG. 1 showing the inner side thereof.

FIG. 4 is a cross-section view of the rotary shock absorber and stop assembly taken along the line 4-4 in FIG. 1.

FIG. 5 is a cross-section view of the rotary shock absorber and stop assembly taken along the line 4-4 in FIG. 1.

FIG. 6 is a fragmentary enlarged view of a portion of FIG. 5.

FIG. 7 is a diagrammatic view of the stator plate and the rotor in a ready position.

FIG. 8 is a diagrammatic view of the stator plate and the rotor in a shock absorbing decelerating position with the rotor rotating clockwise rotary direction.

FIG. 9 is a diagrammatic view of the stator plate and the rotor in a stopped position.

FIG. 10 is a diagrammatic view of the stator plate and the rotor in a resetting position with the rotor rotating in a counterclockwise rotary direction.

FIG. 11 is a perspective view of an actuation assembly attached to the rotary shock absorber and stop assembly.

FIG. 12 is a cross-section taken along the line 12-12 in FIG. 11.

FIG. 13 is a fragmentary view of an alternative embodiment of a lobe of the rotor shown with a relief opening and a slot in phantom.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

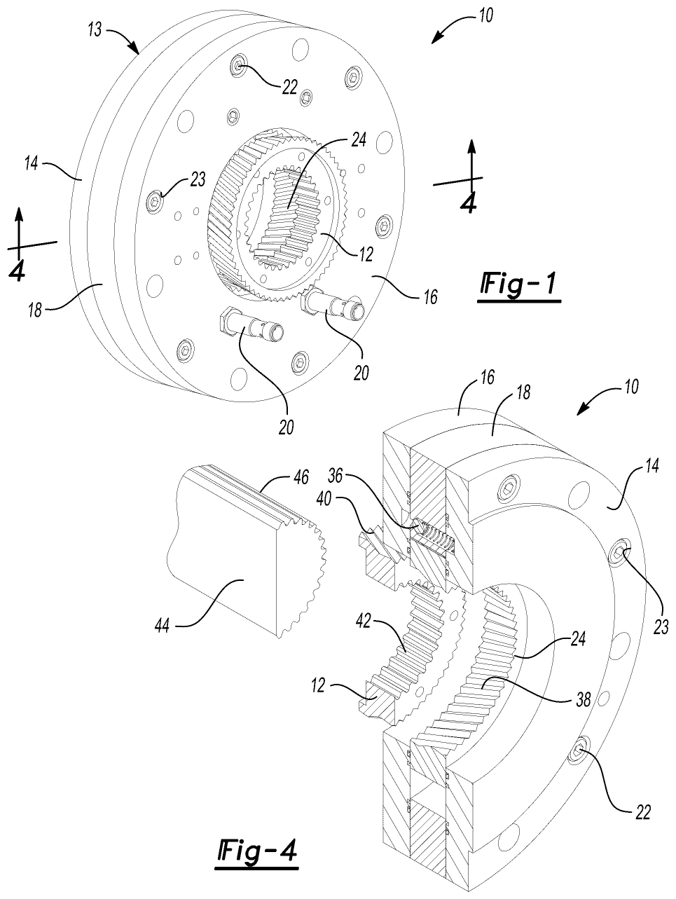

Referring to FIG. 1, a rotary shock absorber and stop assembly 10 is illustrated that is adapted to be secured to the shaft of a lifting machine. The rotary shock absorber and stop assembly 10 can be used as an emergency or fail-safe device that remains passive and only operates when needed. The rotary shock absorber and stop assembly 10 defines limits of motion and is capable of holding a sustained load. The rotary shock absorber and stop assembly 10 functions to decelerate and stop a large, inertial, rotary load and hold that load against gravity or another driving or over-running external force causing torsion to be applied to the shaft.

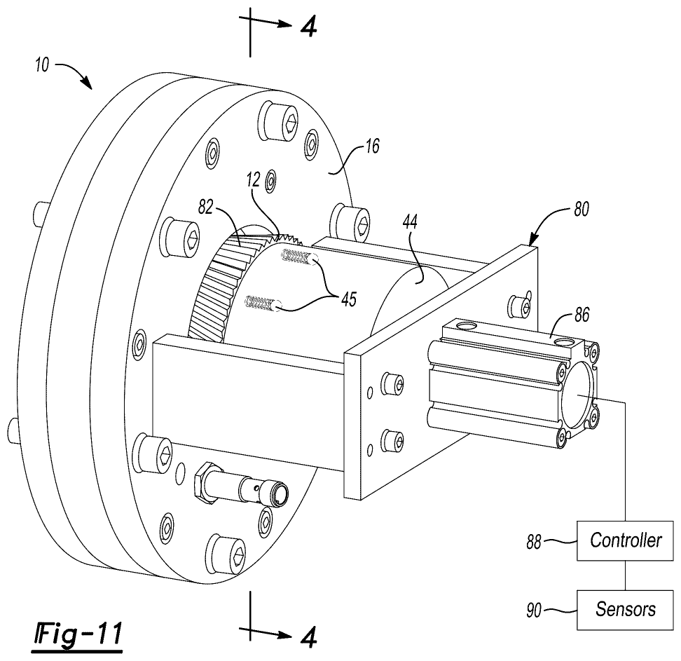

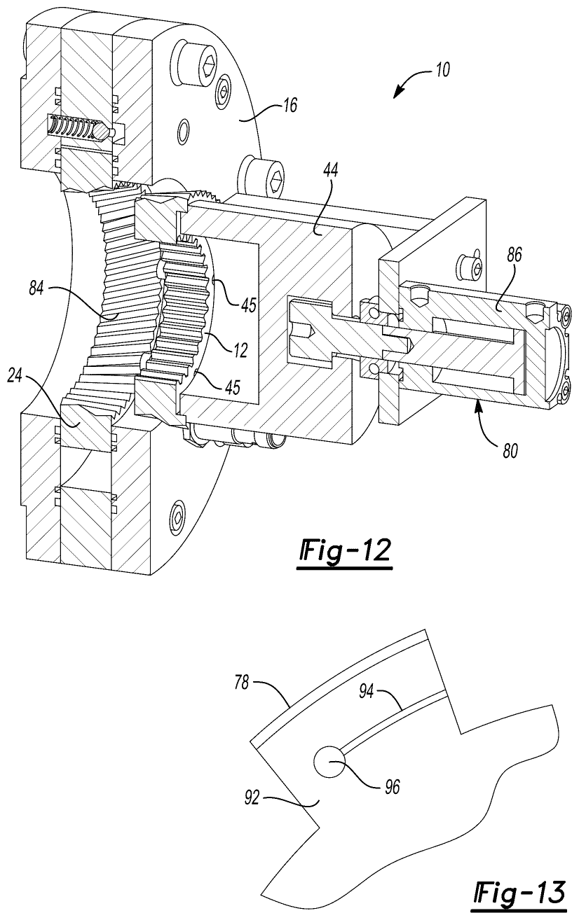

The rotary shock absorber and stop assembly 10 drives a tapered spline ring 12 into engagement with a rotor 24 when sensors detect a falling load. The tapered spline ring 12 is driven axially by a plurality of springs to engage the rotor 24 when a solenoid (shown in FIGS. 11 and 12) or other linear drive mechanism holds the tapered spline ring 12 out of engagement with the rotor 24 when in the normal position, or ready position. The rotary shock absorber and stop assembly 10 has a stator assembly 13 that includes an outer plate 14, an inner plate 16, and a stator plate 18. Magnetic proximity switches 20 are shown to be attached to the inner plate 16 that are used to detect the lock and reset positions of the rotor 24. The assembly is secured together by fasteners 22 such as bolts.

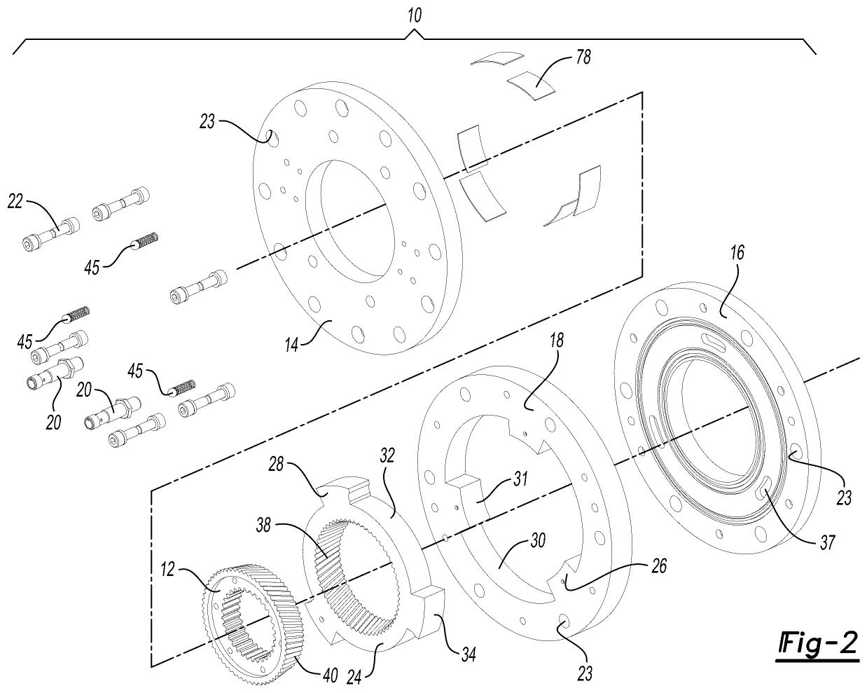

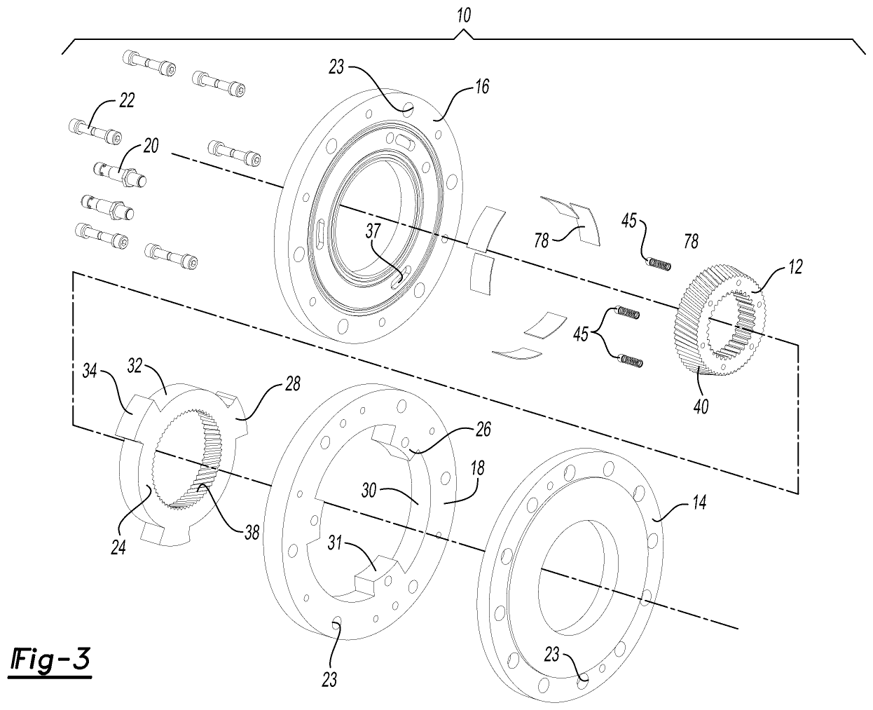

Referring to FIGS. 2 and 3, the rotary shock absorber and stop assembly 10 is shown in an exploded perspective view to include the stator plate 18 that includes a plurality of first lobes 26 and a rotor 24 that includes a second plurality of lobes 28. The first plurality of lobes 26 extend radially inwardly from the stator plate 18. The second plurality of lobes 28 extend radially outwardly from the rotor 24. A second plurality of concave surfaces 31 is provided on the inner end of the first plurality of lobes 26. A first plurality of concave surfaces 30 is provided between each of the first plurality of lobes 26. A second plurality of convex surfaces 34 is provided on an outer end of the second plurality of lobes 28.

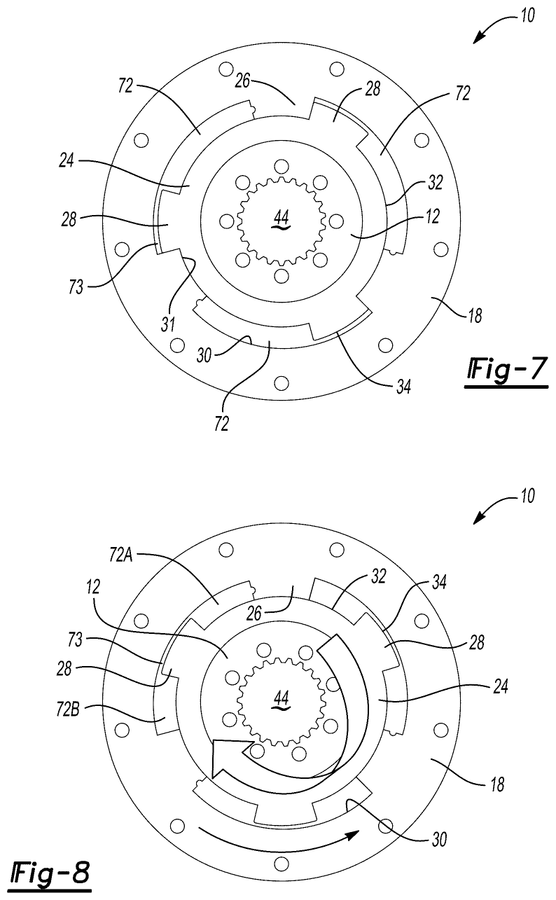

The first plurality of concave surfaces 30 and the second plurality of convex surfaces 34 are both arcuate. The first plurality of concave surfaces 30 is eccentric relative to the second plurality of convex surfaces 34 as they are rotated but are concentric when in the stop position. The radii of the first plurality of concave surfaces 30 and the second plurality of convex surfaces 34 are substantially equal. The first plurality of concave surfaces 30 are not concentric with the rotational axis of the rotor. Relative rotary motion between the rotor 24 and stator assembly 13 toward the stop position creates a decreasing gap between the plurality of first concave surfaces 30 and the second plurality of convex surfaces 34. The rotor 24 moves away from the stop position when the rotary shock absorber 10 is reset and the gap between the plurality of first concave surfaces 30 and the second plurality of convex surfaces 34 increases. This relationship will be described in greater detail below with reference to FIGS. 7-10

Referring to FIGS. 2-4, check valves 36 are provided in the stator plate 18 that prevent the flow of hydraulic fluid between adjacent cavities when the rotary shock absorber and stop assembly 10 is used to slow and stop a falling load. The check valves 36 allow the flow of hydraulic fluid when the rotary shock absorber and stop assembly 10 is reset by rotating the rotor 24 in the counterclockwise direction as depicted in the drawing figures (as described below with reference to FIGS. 7-10). The outer plate 14 and inner plate 16 define check valve channels 37 (shown in FIGS. 2-4) that direct the flow of the fluid through the check valve 36 and through the first lobes 26. While in the illustrated embodiments the check valve channels 37 are defined by the outer plate 14 and inner plate 16, the channels could alternatively be defined by the stator plate 18 or by another combination of the plates.

The rotor 24 includes internal tapered splines 38 that are engaged by the external tapered splines 40 provided on the tapered spline ring 12 when a predetermined event is detected by sensors (shown diagrammatically in FIGS. 1 and 11). The external tapered splines 40 engage and disengage the internal tapered splines 38 of the rotor 24. The external tapered splines 40 and internal tapered splines 38 of the rotor 24 are engaged by at least one spring 45 that applies a biasing force to the tapered spline ring 12. After the occurrence of the predetermined event, an axial motion actuator 86 (e.g., a solenoid, an air cylinder, or the like-as shown in FIGS. 11 and 12) is deactivated by a controller 88 allowing at least one spring 45 to bias the tapered spline ring 12 into engagement with the rotor 24. In the event of a power failure, the internal tapered splines 38 of the rotor 24 and the external tapered splines 40 of the tapered spline ring 12 are engaged. The internal tapered splines 38 and the external tapered splines 40 will engage even if they are moving relative to each other.

The tapered spline ring 12 has many small teeth that ensure that the internal tapered splines 38 and external tapered splines 40 engage and disengage from each other when the tapered spline ring 12 is shifted axially on the shaft 44. When engaged, the strength of the engaged splines in shear is comparable to the solid base material and is substantially stronger than the shaft 44.

Referring to FIG. 4, a cross-section is taken through the rotary shock absorber and stop assembly 10 that shows one of the check valves 36. The external splines 40 of the tapered spline ring 12 are shown to be out of engagement with the internal tapered splines 38 of the rotor 24. The outer plate 14 and inner plate 16 are assembled to opposite sides of the stator plate 18. The tapered spline ring 12 is shown to include the external tapered splines 40 on an outer surface and internal shaft splines 42 on an inner surface of the ring 12 that is adapted to be received on the shaft 44 that has external shaft splines 46. While a spline connection is illustrated in FIG. 4, the connection of the tapered spline ring 12 to the shaft 44 may be with a key/keyway connection, by connecting through complimentary shaped connectors, or the like.

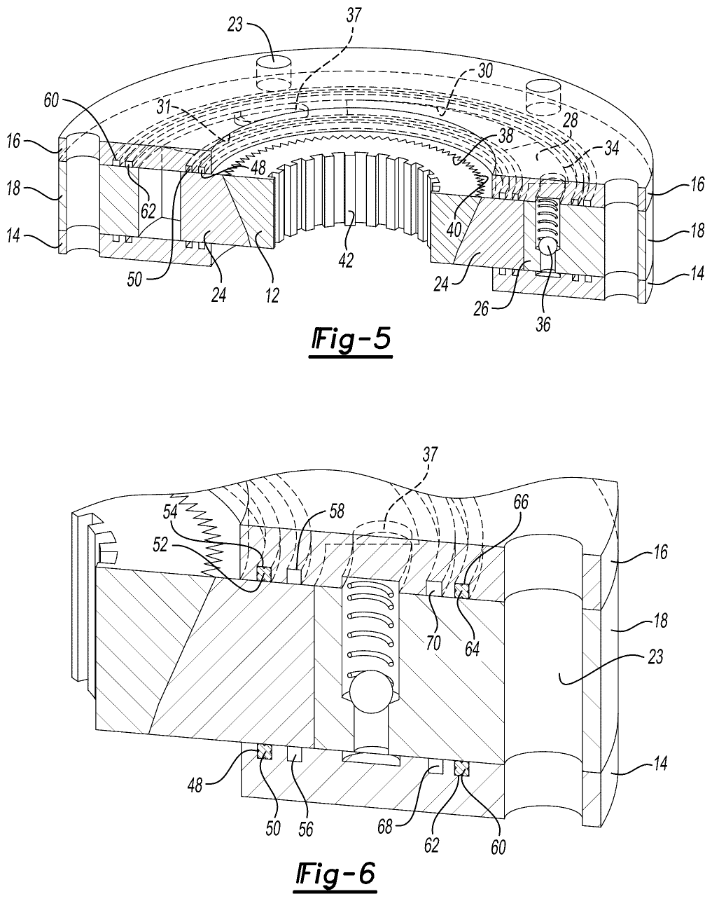

Referring to FIGS. 5 and 6, cross-section views are taken through the rotary shock absorber and stop assembly 10 with the grooves and seals shown in phantom. A first inner seal 48 is received in a first annular inner groove 50 defined by the outer plate 14. A second inner seal 52 is received in a second annular inner groove 54 defined by the inner plate 18. A first pressure equalization inner groove 56 defined by the outer plate 14 outboard relative to the first inner seal 48. A second pressure equalization inner groove 58 is defined by the inner plate 16 radially inboard relative to the second inner seal 52.

A similar sealing arrangement is provided outboard of the reservoir comprising chambers 72A and 72B, wherein a first outer seal 60 is received in a first annular outer groove 62 defined by the outer plate 14. A second outer seal 64 is received in a second annular outer groove 66 defined by the inner plate 16. A first pressure equalization outer groove 68 is defined by the outer plate 14 and is radially inboard of the first outer seal 60. A second pressure equalization outer groove 70 is defined by the inner plate and is disposed radially inboard of the second outer seal 64. The pressure equalization grooves 56, 58, 68, and 70 function to equalize the pressure inside the seals 48, 52, 60, and 64.

Referring to FIGS. 7-10, the rotary shock absorber and stop assembly 10 is diagrammatically illustrated in four different positions.

Referring to FIG. 7, the rotary shock absorber and stop assembly 10 is shown in a ready position and is disengaged from the rotary shaft 44 (shown in FIG. 4). In the ready position, the first lobes 26 are in contact with the second lobes 28 on one side.

Referring to FIG. 8, the rotor 24 is shown to be rotating in the counterclockwise direction after detection of a predetermined event. Detection of the predetermined event causes an axial motion actuator 86 (shown in FIGS. 11 and 12) holding the tapered spline ring 12 to be switched off allowing the springs 45 to shift the tapered spline ring 12 axially and into engagement with the rotor 24. The external tapered splines 40 on the tapered spline ring 12 are driven into the internal tapered splines 38 of the rotor 24.

A fluid reservoir comprising chambers 72A and 72B is defined between the spaced opposite sides of the first lobes 26 and the second lobes 28. In the ready position, the internal pressure is ambient and uniform. The chambers 72A and 72B are each divided by the second lobes 28 into a high-pressure chamber 72A and a low-pressure chamber 72B. When the rotor 24 begins to rotate in a clockwise direction, high pressure is developed between the second plurality of lobes 28 of the rotor 24 and the first plurality of lobes 26 of the stator plate 18. As the motion continues, oil from the high-pressure side 72A flows to the low-pressure side 72B through a gap 73 (alternatively referred to as a space or fluid channel) defined between the first plurality of concave surfaces 30 and the second plurality of convex surfaces 34. As the rotor 24 turns, the cross-sectional area of the gap 73 decreases and approaches zero as a result of the offset centers of the first concave surfaces 30 and the first convex surfaces 34.

Movement of the second lobes 28 relative to the first lobes 26 causes fluid to flow through the gap 73 between the first concave surfaces 30 of the stator plate 18 and the second convex surfaces 34 of the rotor 24. As previously described, the variable gap 73 is provided between the first concave surfaces 30 and the first convex surfaces 34. The fluid in the gap, or space, is squeezed out of the gap between the rotor and stator lobes to form a “squeeze film” between the first plurality of concave surfaces 30 of the stator plate 18 and the first convex surfaces 34 of the rotor 24. The squeeze film resists the flow of the fluid through the gap and acts as a shock absorber.

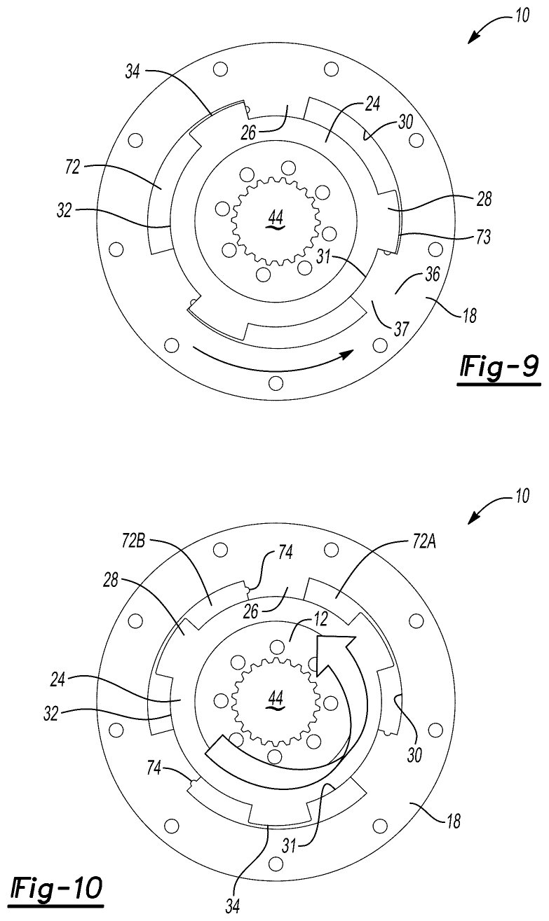

Referring to FIG. 9, the stopped position is illustrated with clockwise rotation of the second lobes 28 relative to the first lobes 26 being stopped when each of the second lobes 28 contact, or closely approach, one of the first lobes 26. At this point, the shaft 44 (shown in FIG. 4) is stopped by the rotary shock absorber and stop assembly 10 and the pressure in the cavities 72 becomes uniform. In the illustrated embodiment, three lobes 28 are provided on the rotor 24 and three lobes 26 are provided on the stator plate 18 as a result the rotor 24 is rotatable through approximately 60 degrees. Two lobes or four or more lobes may be provided depending on system requirements. The extent of angular rotation is defined by lobe dimensions wherein narrower or wider lobes will increase or decrease the extent of angular rotation.

Referring to FIG. 10, The rotary shock absorber and stop assembly 10 is shown to be in the process of being reset. The rotary shaft 44 and tapered spline ring 12 are rotated in the counterclockwise direction with the hydraulic fluid being ported through the check valve 36 and check valve channels 37 from the low-pressure chamber 72A on one side of the first lobes 26 through the first lobes 26 to the high-pressure chamber 72B. The faces of the second lobes 28 define relief grooves 74 that facilitate return of the fluid from adjacent cavities 72 through the check valves 36 and the check valve channels 37. The rotor 24 is rotated in the opposite direction so the pressure in the low-pressure chambers 72A and the high-pressure chambers 72B is reversed with the pressure in the low-pressure reservoirs 72A being higher than the pressure in the high-pressure reservoirs 72B when resetting.

The rotary shock absorber and stop assembly 10 is returned to the ready position shown in FIG. 7. When resetting, the fluid flows through the check valve channels 37 and check valves 36 that are integrally formed in the stator plate 18. The rotary shock absorber and stop assembly 10 is reset and ready to function when the second lobes 28 are positioned against the first plurality of lobes 26, as shown in FIG. 7.

Referring back to FIGS. 2 and 3, polytetrafluoroethylene (PTFE) or other composite pads 78 (hereinafter PTFE pads 78) are shown that are provided on the first concave surfaces 31 of the stator plate 18 and the second convex surfaces 34 of the rotor 24. PTFE pads 78 may also be provided on the second concave surfaces 31 and the first convex surfaces 32. The PTFE pads 78 may be applied as a liquid or as a tape to the first concave surfaces 30 and the second convex surfaces 34 to prevent galling of the respective surfaces when the second lobes 28 are driven toward the first lobes 26. The PTFE pads 78 allow zero clearance fits between the first concave surfaces 30 and the second convex surfaces 34 in the stop position.

Referring to FIGS. 4, 11 and 12, an actuator assembly 80 is shown assembled to the inner plate 16 of the rotary shock absorber 10. The shaft 44 is connected to the tapered spline ring 12 by the internal shaft splines 38 are twisted and the external shaft splines 40 are twisted to facilitate engagement and disengagement thereof. An axial motion actuator 86 as shown is a pneumatic cylinder or hydraulic cylinder but could alternatively be another type of linear motion drive. The axial motion actuator 86 functions to hold the tapered spline ring 12 out of engagement with the rotor 24 when the rotary shock absorber 10 is in normal operation. The controller 88 in response to a predetermined event such as when a falling load is detected by sensors 90 sends a signal to the axial motion actuator 86 cutting off power to the axial motion actuator 86. In the event of a power failure, power to the axial motion actuator 86 is lost and the springs 45 (shown in FIGS. 2 and 3) exert a biasing force on the tapered spline ring 12 to drive the tapered spline ring 12 into engagement with the rotor 24.

Referring to FIG. 13, an alternative embodiment of the lobes 92 on the rotor 24 is illustrated that provides additional resiliency for higher loads applications. The lobes 92 include a slot 94 that is filled with the fluid. An opening 96 is provided at the inner end of the slot 94 that is provided to prevent the lobes 92 from fracturing when the slot 94 is compressed when the rotary shock absorber and stop assembly 10 is triggered by a predetermined event. As with the previous embodiment, PTFE composite pads 78 are provided on the second convex surface of the lobes 92.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A rotary shock absorber and stop apparatus comprising:
a stator assembly including an inner plate, an outer plate, and stator plate assembled together to define a plurality of cavities, wherein the stator plate includes a first plurality of lobes that extend radially inwardly from a first plurality of concave surfaces each disposed between a pair of the first plurality of lobes, the first plurality of lobes and the first plurality of concave surfaces partially define a plurality of cavities; and
a rotor received in the cavities includes a second plurality of lobes that extend radially outwardly from a first plurality of convex surfaces disposed between two of the second plurality of lobes, the second plurality of lobes each have a second convex surface disposed on a radially outer periphery of the lobes, the second convex surfaces are offset relative to the first plurality of concave surfaces and defines a space therebetween, wherein the space between the second convex surface and the first plurality of concave surfaces is diverge from an inlet side through which a fluid is received in the space to an outlet side through which the fluid flows into an adjacent one of the plurality of cavities, wherein at the outlet side the fluid is squeezed to a squeeze film thickness as the second plurality of lobes move in a first rotary direction, and wherein rotation of the second plurality of lobes in the first rotary direction is stopped by contacting a circumferentially adjacent one of the first plurality of lobes.

2. The rotary shock absorber and stop apparatus of claim 1 further comprising:
a plurality of check valves disposed in in a plurality of reset channels defined in either of the first plurality of lobes or each of the second plurality of lobes, each of the reset channels are in fluid communication between two of the plurality of cavities to prevent the fluid from flowing when the lobes are moved in the first rotary direction, wherein each check valve allows the fluid to flow when the second plurality of lobes is moved in a second rotary direction when the rotary shock absorber and stop apparatus is reset.

3. The rotary shock absorber and stop apparatus of claim 1 wherein each of the second plurality of lobes is movably disposed in the plurality of cavities, wherein the plurality of cavities define a low-pressure chamber defined between a first side of the first plurality of lobes and a first side of the second plurality of lobes and a high-pressure chamber defined between a second side of the first plurality of lobes and the and a second side of the second plurality of lobes, wherein the fluid flows from the high-pressure chamber of the plurality of cavities to the low-pressure chamber of the plurality of cavities when the first plurality of lobes and the second plurality of lobes move relative to each other when a predetermined event occurs.

4. The rotary shock absorber and stop apparatus of claim 3 further comprising:
a plurality of check valves disposed in a plurality of reset channels defined in each of the first plurality of lobes or the second plurality of lobes, each of the plurality of reset channels are in fluid communication between two of the plurality of cavities to prevent the fluid from flowing through the plurality of reset channels when the second plurality of lobes are moved in the first rotary direction, wherein each check valve allows the fluid to flow from the low-pressure chamber defined by the cavities when the second plurality of lobes moves in a second rotary direction when the rotary shock absorber and stop apparatus is reset, wherein the fluid flows through the plurality of reset channels from the low-pressure chamber of the plurality of cavities to the high-pressure chamber of the plurality of cavities when the second plurality of lobes moves in the second rotary direction.

5. The rotary shock absorber and stop apparatus of claim 1 wherein the second plurality of lobes and the first plurality of lobes contact each other in a ready position, wherein a pressure applied to the fluid in the cavities is substantially equal throughout the cavities, when a load drops that is supported by a rotary shaft occurs, the rotor rotates in a first rotary direction and defines a high-pressure chamber of the cavities being created at a leading surface of the second plurality of lobes and defines a low-pressure chamber of the cavities being created at a trailing surface of the second plurality of lobes, and wherein the second plurality of lobes move in the first rotary direction until the second plurality of lobes contact a next adjacent one of first plurality of lobes thereby stopping rotation in the first rotary direction.

6. The rotary shock absorber and stop apparatus of claim 1 wherein the first plurality of concave surfaces of the stator assembly are circular arcs, and the first plurality of concave surfaces are offset relative to the first plurality of convex surfaces to form the space that diverges from an inlet side to an outlet side of the space, wherein the outlet side is narrower than the inlet side.

7. The rotary shock absorber and stop apparatus of claim 1 further comprising:
a ring adapted to be attached to a rotary shaft, wherein the ring has external splines that selectively engage and disengage a splined opening defined by the rotor that has internal splines, the ring being shifted in an axial direction relative to the rotor to engage the internal splines of the rotor with the internal splines of the ring when the rotor rotates in the first rotary direction by a falling load, and wherein the ring is disconnected from the internal splines of the rotor in a ready position.

8. The rotary shock absorber and stop apparatus of claim 7 wherein the internal splines and the external splines are tapered at a complementary angle to each other, and wherein the external splines are axially moved to engage the internal splines when the rotor is rotated in a first direction by the falling load, and wherein the external splines disengage the internal splines to reset the rotary shock absorber and stop apparatus in a ready position.

9. The rotary shock absorber and stop apparatus of claim 8 wherein the internal splines have a first plurality of spline teeth, and the external splines have a second plurality of spline teeth, wherein the internal splines and the external splines are twisted and extend in an axial direction and a circumferential direction.

10. The rotary shock absorber and stop apparatus of claim 1 wherein the outer plate covers a first side of the stator plate and a first side of the rotor, the inner plate covers a second side of the stator plate and a second side of the rotor,
a first inner seal is disposed between the outer plate and the first side of the rotor radially inboard from the plurality of cavities;
a second inner seal is disposed between the inner plate and the second side of the rotor radially inboard from the plurality of cavities;
a first outer seal is disposed between the outer plate and the second side of the stator plate radially outboard from the plurality of cavities; and
a second outer seal is disposed between the inner plate and the second side of the stator plate radially outboard from the plurality of cavities.

11. The rotary shock absorber and stop apparatus of claim 10 wherein the outer plate covers a first side of the stator plate and a first side of the rotor, the inner plate covers a second side of the stator plate and a second side of the rotor,
a first outer pressure equalization groove is disposed between the outer plate and the first side of the rotor radially inboard from the plurality of cavities and outboard of the first inner seal;
a second inner pressure equalization is disposed between the inner plate and the second side of the rotor radially inboard from the plurality of cavities and radially outboard of the second inner seal;
a first outer pressure equalization groove is disposed between the outer plate and the first side of the stator plate radially inboard from the plurality of cavities and inboard of the first outer seal; and
a second outer seal pressure equalization groove is disposed between the inner plate and the second side of the stator plate radially outboard from the plurality of cavities and inboard of the first outer seal.

12. A rotary shock absorber and stop apparatus comprising:
a stator assembly defining a plurality of cavities that are filled with a fluid, wherein the stator assembly includes a first plurality of lobes, and wherein the stator assembly includes a first plurality of concave arcuate surfaces between each of the first plurality of lobes; and
a rotor received in the plurality of cavities, the rotor including a second plurality of lobes, wherein the second plurality of lobes each have a second plurality of convex arcuate surfaces on a radially outer periphery of the second plurality of lobes, wherein the rotary shock absorber and stop apparatus is actuated when a falling load supported by a shaft falls causing the rotor to rotate in a first rotary direction relative to the stator assembly causing the fluid to flow from high-pressure chambers to low-pressure chambers through spaces defined by the second convex arcuate surfaces and first concave arcuate surfaces, wherein the fluid in the low-pressure chamber is subjected to lower pressure than is applied to the fluid in the high-pressure chamber, and wherein the rotor rotates relative to the stator assembly with the fluid being squeezed through the first plurality of concave arcuate surfaces and the second plurality of convex arcuate surfaces, wherein the second plurality of convex arcuate surfaces are offset relative to the first plurality of concave arcuate surfaces and define spaces therebetween that convergent, and wherein when the rotor rotates in the first rotary direction the second plurality of lobes are driven into contact with the first plurality of lobes to stop rotation of the rotor.

13. The rotary shock absorber and stop apparatus of claim 12 further comprising:
a check valve disposed in either of the first plurality of lobes or second plurality of lobes, wherein the check valve is in fluid communication with one of the low-pressure chambers and one of the high-pressure chambers to prevent the fluid from flowing from the low-pressure chambers to the high-pressure chambers when the rotary shock absorber and stop apparatus is actuated by the falling load supported by the shaft, wherein the check valves allow the fluid to flow from the low-pressure chambers to the high-pressure chambers when the rotary shock absorber and stop apparatus is reset by rotating the rotor relative to the stator assembly in a second rotary direction, opposite the first rotary direction.

14. The rotary shock absorber and stop apparatus of claim 13 wherein the first plurality of lobes and the second plurality of lobes engage each other in a ready position wherein pressure applied to the fluid in the cavities is substantially equal throughout the cavities, when the rotary shock absorber and stop apparatus is actuated by the falling load supported by the shaft the rotor rotates in the first rotary direction with the high-pressure chamber of the cavities being created at a leading surface of the lobes and a low-pressure chamber of the cavities being created at a trailing surface of the lobes, and wherein the second plurality of lobes move in the first rotary direction until the second plurality of lobes reaches a next adjacent one of the first plurality of lobes thereby stopping rotation in the first rotary direction.

15. The rotary shock absorber and stop apparatus of claim 12 wherein the first plurality of concave arcuate surfaces are circular arcs, and the second plurality of convex arcuate surfaces are circular arcs and are eccentric relative to the first plurality of concave arcuate surfaces to form spaces therebetween that are convergent.

16. The rotary shock absorber and stop apparatus of claim 12 further comprising:
a tapered spline ring including tapered external splines, wherein the rotor defines an opening including internal splines that are adapted to receive the tapered external splines when the falling load supported by the shaft is sensed.

17. The rotary shock absorber and stop apparatus of claim 16 wherein the internal splines and the tapered external splines are tapered at a complementary angle, and wherein the tapered external splines are axially moved in a first direction to engage the internal splines when actuated by the falling load supported by the shaft, wherein the tapered external splines are moved in a second axial direction to disengage the internal splines to reset the rotary shock absorber and stop apparatus in a ready position.

18. The rotary shock absorber and stop apparatus of claim 12 wherein the stator assembly further comprises:
a stator plate including the first plurality of lobes;
an outer plate covers a first side of the stator plate and a first side of the rotor; and
an inner plate covers a second side of the stator plate and a second side of the rotor.

19. The rotary shock absorber and stop apparatus of claim 18 further comprising:
a first inner seal disposed between the outer plate and the first side of the rotor, wherein the first inner seal is disposed radially inboard from the plurality of cavities;
a second inner seal disposed between the inner plate and the second side of the rotor, wherein the second inner seal is disposed radially inboard from the plurality of cavities;
a first outer seal disposed between the inner plate and the first side of the stator assembly, wherein the first outer seal is disposed radially outboard from the plurality of cavities; and
a second outer seal disposed between the outer plate and the second side of the stator assembly, wherein the second outer seal is disposed radially outboard from the plurality of cavities.

20. The rotary shock absorber and stop apparatus of claim 19 wherein the outer plate covers a first side of the stator plate and a first side of the rotor, the inner plate covers a second side of the stator plate and a second side of the rotor,
a first inner pressure equalization groove is disposed between the outer plate and the first side of the rotor radially inboard from the cavities and outboard of the first inner seal;
a second inner pressure equalization is disposed between the inner plate and the second side of the rotor radially inboard from the plurality of cavities and radially outboard of the second inner seal;
a first outer pressure equalization groove is disposed between the outer plate and the second side of the stator plate radially outboard from the cavities and outboard of the first outer seal; and
a second outer seal pressure equalization groove is disposed between the inner plate and the second side of the stator plate radially outboard from the cavities and outboard of the first outer seal.
